(19) United States
(12) Patent Application Publication
(10) Pub. No.: US 2025/0085145 A1
(43) Pub. Date: Mar. 13, 2025

(54) METHOD AND SYSTEM FOR SELF-DIAGNOSING OF PREASSEMBLED ULTRASONIC FLOWMETER

(71) Applicant: BELIMO HOLDING AG, Hinwil (CH)

(72) Inventors: Patrick REISSNER, Herrliberg (CH); Lucien BUCHMANN, Rapperswil (CH)

(73) Assignee: BELIMO HOLDING AG, Hinwil (CH)

(21) Appl. No.: 18/292,740

(22) PCT Filed: Jul. 11, 2022
(86) PCT No.: PCT/EP2022/069270

§ 371 Date: Jan. 26, 2024

(30) Foreign Application Priority Data
Jul. 27, 2021 (CH) 070102/2021

(51) Int. Cl. G01F 1/66; G01F 25/10; G01K 11/24; G01K 13/024; G01K 15/00

(52) U.S. Cl. CPC G01F 1/662; G01F 25/10; G01K 11/24; G01K 13/024; G01K 15/005; G01K 15/007; G01K 2201/00

(57) ABSTRACT

A method for self-diagnosing an ultrasonic flowmeter assembly (I) comprising at least one ultrasonic transducer (20, 21) fixed to the conduit section (3) and configured to emit ultrasonic pulses into the conduit (3) and to receive ultrasonic pulses after having travelled along at least one path (R, I) in the conduit section (3) and to output measurement data, further comprising a controller (200) for processing the measurement data, wherein a reference measurement and test measurement each comprises emitting and receiving at least one ultrasonic pulse along at least one same or comparable path (R). The method comprises: (a) providing a reference measurement data; (b) obtaining a test measurement data; (c) comparing the reference and test measurement data, wherein the reference measurement data (A) comprises an ultrasonic reference signal characteristic (51,61), and the test measurement data (B) comprises an ultrasonic test signal characteristic (52, 62).

### FIELD OF THE INVENTION

The present invention relates to a system and method for diagnostics of ultrasonic sensors. In particular, it relates to self-diagnosing of preassembled ultrasonic flowmeters used preferably in heating, ventilation and air conditioning (HVAC) systems.

### BACKGROUND

The use of ultrasonic sensors and ultrasonic flowmeters in an HVAC (heating, ventilation and air conditioning) systems has grown significantly due to their many beneficial features such as high accuracy, non-intrusive nature and lack of moving parts. WO 2010/122117 discloses a system comprising ultrasonic sensors, and in particular it describes a ventilation system which draws air from an exterior of a building through a ventilation duct into an interior of the building. The ventilation system has an ultrasonic sensor positioned in the ventilation duct upstream and/or downstream of the ventilator for measuring the volume flow or air velocity. The ultrasonic sensor of WO 2010/122117 comprises a pair of ultrasonic transceivers which are mounted in a spaced apart relationship facing each other on opposing surfaces of the ventilation duct, emitting and receiving ultrasonic waves in an angle between 60-90 degrees relative to the surface of the ventilation duct in upstream and downstream direction. In a controller, the phase difference and time-of-flight difference between the transmitted and received ultrasonic signals in upstream and downstream direction are determined and used to calculate the velocity and temperature of the air and to control these parameters by a controller that communicates with a valve to regulate the temperature and velocity of the airflow and to control the fan speed and temperature of the ventilation unit by communication through the control box on the valve.

To assure proper operation, ultrasonic flowmeters and assemblies need regular maintenance and diagnostics of the whole system and/or the individual parts of the system. Typically, the whole flowmeter assembly is removed and inspected and/or recalibrated at a service station. This operation produces additional costs and time delays. For this reason, there is still need for effective ultrasonic flowmeters that are capable of self-diagnostics without removing them from the operating site.

Another problem may arise when variable air volume (VAV) boxes are installed in a reversed flow direction without such wrong installation being detected. This causes wrong measurement values and can lead to failures of the entire ventilation system.

### SUMMARY

Therefore, it is an object of the present disclosure to propose a method and system for self-diagnosing an ultrasonic flowmeter assembly, which does not have at least some of the disadvantages of the prior art.

According to the present disclosure, this object is achieved by the features of the independent claims. Moreover, further advantageous embodiments emerge from the dependent claims and claim combinations, the description and drawings.

A method for self-diagnosing an ultrasonic flowmeter assembly which is designed for measuring a flow and/or temperature of a fluid through a channel is proposed. The ultrasonic flowmeter assembly is comprising: a conduit section extending in an axial direction; an ultrasonic sensor comprising at least one ultrasonic transducer that is fixed to the conduit section, wherein the at least one ultrasonic transducer is configured to emit ultrasonic pulses into the conduit and to receive ultrasonic pulses after having travelled along at least one path in the conduit section and to output measurement data; the ultrasonic sensor is further comprising a controller connected to the ultrasonic transducer for processing the measurement data, wherein a reference measurement and a test measurement each comprises emitting and receiving at least one ultrasonic pulse along at least one same or comparable path. The method is comprising the method elements of: providing a reference measurement data; obtaining a test measurement data; comparing the reference measurement data and the test measurement data, wherein the reference measurement data comprises a reference signal characteristic of at least one received ultrasonic pulse of the reference measurement, and the test measurement data comprises a test signal characteristic of at least one received ultrasonic pulse of the test measurement.

The following embodiments include modifications, improvements and/or variations of the method for self-diagnosing an ultrasonic flowmeter assembly.

In an embodiment, the ultrasonic sensor comprises at least two ultrasonic transducers that are fixed to the conduit section and are arranged at a distance from each other along the axial direction, and they are configured to emit ultrasonic pulses into the conduit and to receive ultrasonic pulses after having travelled along at least one path in the conduit section.

In an embodiment, the reference measurement data is obtained at least once before or after installation of the ultrasonic flowmeter assembly at a site of operation. In another embodiment the test measurement data is obtained repeatedly after installation of the ultrasonic flowmeter assembly at the site of operation. In yet another embodiment, obtaining the reference measurement data is performed during commissioning or during a first start-up procedure of the ultrasonic flowmeter assembly.

In an embodiment, obtaining the test measurement data is performed automatically as a part of subsequent start-up procedures of the ultrasonic flowmeter assembly. In another embodiment obtaining the test measurement data is initiated repeatedly by the controller. Such repeated obtaining of the test measurement data can be performed during a period of operation or readiness for operation of the ultrasonic flowmeter assembly or the method for self-diagnosing.

In an embodiment, the ultrasonic flowmeter assembly is part of a variable air volume (VAV) box, which is installable in the channel. In another embodiment, obtaining the reference measurement data and the test measurement data is done without flow of fluid through the channel, in particular by closing a damper of the variable air volume (VAV) box during normal operation to enforce zero flow.

In embodiment, comparing the reference measurement data and the test measurement data comprises comparing the reference signal characteristics and the test signal characteristics and deriving at least one characteristic parameter for quantifying a deviation of the test signal characteristics from the reference signal characteristics.

In an embodiment, the reference and/or test signal characteristic is or are a waveform of the ultrasonic pulse. In one variation of this embodiment, the signal characteristic parameter is derived from waveform quantities selected from the list of: an intensity of a waveform amplitude, a shape of a waveform amplitude, a position of a waveform zero-crossing, a position of a waveform extremum, a waveform frequency, and a shape of an enveloping function. Other signal characteristic parameters can also be used.

In an embodiment, the method further comprises an additional step of identifying a cause of a defect of the ultrasonic flowmeter assembly based on the step of comparing, in particular based on the at least one characteristic parameter quantifying a deviation of the test signal characteristics from the reference signal characteristics. The identified cause may be one or more of: a change in a conduit dimension, a change of functioning or malfunctioning of the ultrasonic sensor, a dirt accumulation on the at least one ultrasonic transducer, and an interference with an object in the conduit section.

In an embodiment, the method further comprising the step of activating an alarm based on the step of comparing, when the characteristic parameter exceeds a threshold value.

In an embodiment, the ultrasonic pulse is emitted and received by the same transducer and travels along an I-shaped path and/or a triangular path (also called delta-shaped path) and/or a quadrilateral path (also called diamond-shaped path) and/or a reflected path reflected from a rectangular corner (also called K-path) and/or a direct or non-reflective path (also called single-pass I-shaped path), in particular for identifying a change in a conduit dimension.

Alternatively or in addition, the ultrasonic pulse is emitted by a first of the two transducers and is received by a second of the two transducers and travels along a single-pass I-path, in particular for identifying a change in a conduit dimension.

In an embodiment, the ultrasonic pulse is emitted by a first of the two transducers and is received by a second of the two transducers, and in particular wherein the ultrasonic pulse is emitted along a V-shaped path and/or a U-shaped path, preferably for measuring a flow and/or temperature of the fluid.

In an embodiment, the V-shaped path and the U-shaped path are both used, a first characteristic parameter is determined from the reference measurement data and the test measurement data along the V-shaped path, a second characteristic parameter is determined from the reference measurement data and the test measurement data along the U-shaped path, and a change of the first and/or second characteristic parameter, in particular a change in their relationship, is used to identify a cause of defect of the ultrasonic flowmeter assembly.

In an embodiment, the I-shaped path and the delta-shaped path are both used, a first characteristic parameter is determined from the reference measurement data and the test measurement data along the I-shaped path, a second characteristic parameter is determined from the reference measurement data and the test measurement data along the delta-shaped path, and a change of the first and/or second characteristic parameter, in particular a change in their relationship, is used to identify a cause of defect of the ultrasonic flowmeter assembly.

In an embodiment, the step of comparing the reference measurement data and the test measurement data comprises creating a correlation of the reference signal characteristics and the test signal characteristics and using the correlation as the at least one characteristic parameter.

In an embodiment, the reference signal characteristics is stored in the controller; and/or the test signal characteristics is obtained from the controller; and/or the controller performs the self-diagnosing. In yet another embodiment, the reference signal characteristics and/orthe test signal characteristics is or are obtained by or after conditioning of the measurement data or averaging at least two measurements.

In an embodiment, a reference measurement and a test measurement each comprises emitting and receiving at least one ultrasonic pulse along two different paths, comparing the reference measurement data and the test measurement data for both of the different paths, wherein each one of the two different paths is given a weight factor defining the deviation between test and reference measurement, and the path with highest weight factor corresponding to least deviation is selected for flow measurement and/or fluid temperature measurement and/or channel dimension measurement. The ultrasonic temperature measurement has the advantage that an average temperature along the ultrasonic measurement path can be determined. This allows fluid temperature measurement with high precision and increased robustness. A field of application can be in air enhancement systems.

In an embodiment, a reference path during obtaining the reference measurement data and a testing path during obtaining the test measurement data are identical, or are comparable by having known differences in length, orientation and/or shape that can be compensated for by calculation.

In embodiments or in another aspect of the invention, the ultrasonic flowmeter assembly as disclosed herein comprises in addition a damper system, e.g. is or is part of a VAV box. In such a case, a reversed installation direction of the ultrasonic flowmeter assembly including the damper system relative to the flow direction can be detected and can be corrected for. Reversed installation means that the damper system is arranged upstream of the ultrasonic sensor, or in other words the ultrasonic sensor, in particular the ultrasonic transducer(s), is or are arranged downstream of the damper system. This may cause turbulences of the fluid flow at the ultrasonic flowmeter, in particular its ultrasonic transducers, and reduce the precision of flow measurement and/or temperature measurement and/or measurement of conduit shape or conduit dimension(s).

In embodiments thereof, the VAV box, or the ultrasonic flowmeter assembly as disclosed herein with damper system, is designed such, in particular the paths in the conduit section are selected such, that a flow of fluid in and against flow direction can be measured and a fluid flow direction can be determined. In particular, the fluid flow direction is output to the user, e.g. is represented by a sign of measured time-of-flight difference values or measured flow, e.g. measured volumetric flow or flow velocity.

In further embodiments thereof, the fluid flow direction can be monitored and an absolute value of flow, e.g. absolute volumetric flow or flow velocity, is output to the user. This can be implemented by multiplying a negative flow, e.g. negative volumetric flow or flow velocity, by a negative multiplication factor, in particular minus 1. This has the advantage that the VAV box or ultrasonic flowmeter assembly is still working. However, such reversed installation can reduce the measurement precision, e.g. by up to 50%. Therefore, a warning alarm can be sent to the user. The warning alarm should only be triggered, if a certain negative flow threshold is surpassed. Otherwise noise comprising negative flow values could be misinterpreted as reverse flow. Alternatively or in addition, the measurement output is set by the ultrasonic sensor to a minimal volumetric flow such that the damper system opens completely, thereby always ensuring flow of fluid or air. This allows to avoid failure of the entire ventilation system.

In further embodiments thereof, the reference signal characteristic and the test signal characteristic as disclosed herein each contains information about the fluid flow direction, e.g. by providing direction-sensitive flow measurement as disclosed herein. This allows to detect a reversed installation direction, in which the ultrasonic sensor is arranged downstream of the damper system, by comparing the reference and test signal characteristics and detecting a deviation indicative of reversed flow direction. In such a case, a (e.g. pre-stored) corrective calibration curve of the ultrasonic sensor can be activated or applied in the controller, which calibration curve is designed to compensate ultrasonic signal deviations caused by the reversed installation. Alternatively or in addition, an output to the user can be corrected by a negative multiplicative correction factor, in particular multiplication factor of minus one, to output an absolute value of the measured volumetric flow or flow velocity.

A further aspect of the invention is related to a computer program product comprising instructions which, when the program is executed by a computer, cause the computer to carry out the steps of the method for self-diagnosing an ultrasonic flowmeter assembly as disclosed herein.

Another aspect of the invention relates to an ultrasonic flowmeter assembly for performing the method for self-diagnosing as disclosed herein.

### BRIEF DESCRIPTION OF THE DRAWINGS

The present invention will be explained in more detail, by way of non-limiting examples, with reference to the schematic drawings in which:

FIG. 1a shows in lateral view (on the left) and cross-sectional view (on the right) an ultrasonic flowmeter assembly designed for measuring a flow and/or temperature of a fluid through a round channel by using an I-shaped path of ultrasonic transmission according to embodiments of the invention;

FIG. 1b shows in lateral view (on the left) and cross-sectional view (on the right) an ultrasonic flowmeter assembly designed for measuring a flow and/or temperature of a fluid through a round channel by using a delta-shaped path of ultrasonic transmission according to embodiments of the invention;

FIG. 1c shows in lateral view (on the left) and cross-sectional view (on the right) an ultrasonic flowmeter assembly designed for measuring a flow and/or temperature of a fluid through a round channel by using a direct non-reflective path of ultrasonic transmission according to embodiments of the invention;

FIG. 1d shows in lateral view an ultrasonic flowmeter assembly with damper system and means for detecting a reversed installation with wrong flow direction through the ultrasonic sensor according to an aspect or embodiments of the invention;

FIG. 2a shows in lateral view (on the left) and cross-sectional view (on the right) an ultrasonic flowmeter assembly designed for measuring a flow and/or temperature of a fluid through a round channel by using a V-shaped path of ultrasonic transmission according to embodiments of the invention;

FIG. 2b shows in lateral view (on the left) and cross-sectional view (on the right) an ultrasonic flowmeter assembly designed for measuring a flow and/or temperature of a fluid through a round channel by using a U-shaped or quasi-helical path of ultrasonic transmission according to embodiments of the invention;

FIG. 3a, 3b, 3c show in lateral view (on the left) and cross-sectional view (on the right) an ultrasonic flowmeter assembly designed for measuring a flow and/or temperature of a fluid through a rectangular channel using an I-shaped or diamond-shaped or K-path of ultrasonic transmission according to embodiments of the invention;

FIG. 4a, 4b show an illustration of ultrasonic signal waveforms detected by the ultrasonic sensor according to the invention;

FIG. 5, 6, 7 show ultrasonic signal waveforms detected by the ultrasonic sensor for a reference measurement and a test measurement.

### DETAILED DESCRIPTION

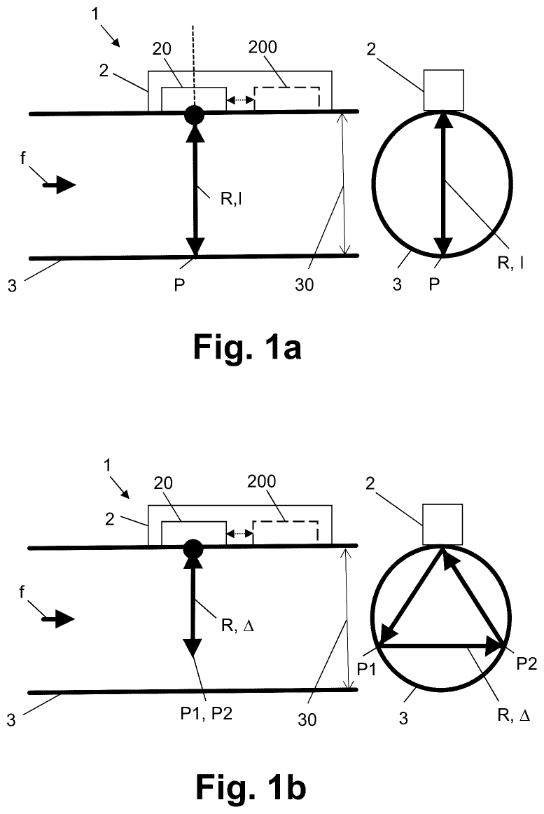

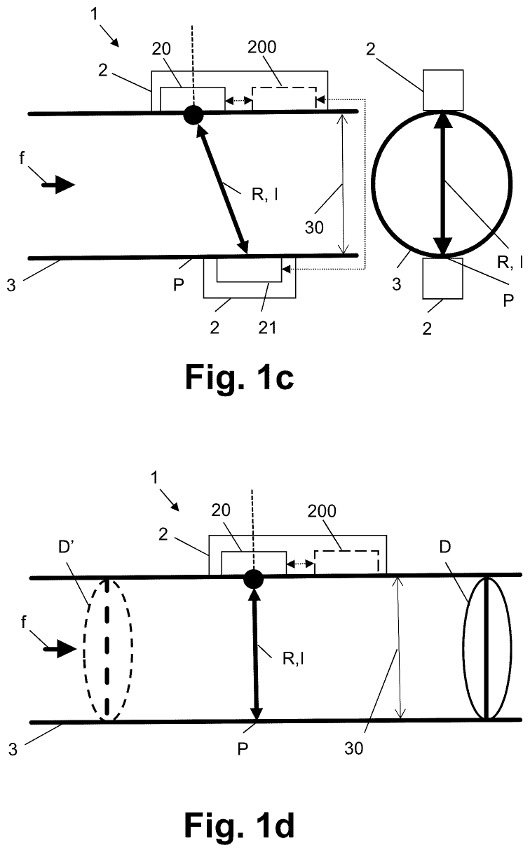

FIG. 1a and FIG. 1b show exemplary embodiments of an ultrasonic flowmeter assembly 1 designed for measuring a flow and/or temperature of a fluid through a channel according to the invention. The ultrasonic flowmeter assembly 1 may be preassembled and configured to be attached to the channel having a flow direction f through the channel. The channel may be an integral part of a larger system such as an HVAC system, and it may have different cross section profiles such as, but not limited to, circular or rectangular.

The ultrasonic flowmeter assembly 1 shown in FIG. 1a and FIG. 1b comprises a conduit section 3 extending in an axial direction. In these embodiments, the conduit section 3 has a circular cross section profile characterized by at least one dimensional parameter 30, here a diameter in case of a circular shape. The ultrasonic flowmeter assembly 1 comprises at least one ultrasonic transducer 20 that is fixed directly or indirectly to the conduit section 3, i.e. is brought into an at least temporarily stable position relative to the conduit section 3. The ultrasonic transducer 20 is configured to emit ultrasonic pulses into the conduit 3 and to receive ultrasonic pulses after having travelled along at least one path R in the conduit section 3 and to output measurement data. In the embodiment of FIG. 1a the path is a double pass I-shaped path, which is characterized in that the ultrasonic pulse emitted by the ultrasonic transducer 20 is reflected back to the ultrasonic transducer 20. The path R may preferably be chosen to lie in a plane orthogonal to the flow direction f or a longitudinal axis of the conduit 3. In the double pass I-shaped path shown in FIG. 1a, the ultrasonic pulse is reflected once at a reflection point or a reflection area P.

FIG. 1c shows another embodiment, in which the path R may be a direct or single pass I-shaped path. After emission from the first ultrasonic transducer 20, the ultrasonic pulses traverse the channel section 3 once and are received by the second ultrasonic transducer 21, which also forms part of the ultrasonic sensor 2 and is communicatively connected to the controller 200, as indicated by the dotted double-arrowed communication line.

In embodiment of FIG. 1b, the reflection path is a triangular or delta-shaped path having two reflection points or reflecting areas P1 and P2. The path R may preferably be chosen to lie in a plane orthogonal to the flow direction f or the longitudinal axis of the conduit 3. In this embodiment, the ultrasonic pulse emitted by the ultrasonic transducer 20 is reflected back to the ultrasonic transducer 20.

The ultrasonic transducers 20, 21 may be operating in a range of 20 kHz to 400 kHz and preferably at 40 kHz. The ultrasonic transducers 20, 21 preferably have a broad emission characteristic (or emission angle) and/or receiving characteristic (or receiving angle) to allow measurement and assessment of a plurality of ultrasonic signal paths. The paths can be or comprise reflective paths R, which include one or more reflection points or reflecting areas P. Alternatively or in addition, the ultrasonic signal paths can also be or comprise direct paths.

The ultrasonic sensor 2 may further comprise a controller 200 connected to the ultrasonic transducer(s) 20, 21 for processing the measurement data received from the ultrasonic transducer(s) 20, 21. The at least one ultrasonic transducer 20, 21 is communicatively connected to the controller 200, which is indicated by the dotted double-arrowed communication lines. In typical applications, the controller 200 is used to calculate transit times of ultrasonic pulses in the channel. The controller 200 can be implemented in hardware electronic components and/or software, in particular can comprise a general purpose processor, microcontroller, application-specific integrated circuit (ASIC), field programmable gate array (FPGA), or other electronic component. In one embodiment, the controller 200 may be positioned remotely from the ultrasonic transducer 20, 21. For example, the controller need not be attached to the conduit 30, but can rather be connected to the ultrasonic transducer 20, 21 via wired or wireless connection.

According to the invention, before installation on the site, the ultrasonic flowmeter assembly 1 may be calibrated for example at a factory site. The calibration data may be stored for the future use as one type of a reference measurement data. The same or similar calibration procedure may be performed after installation on the site before starting the operation. Between calibration and being operational on the site, the ultrasonic flowmeter assembly 1 might be transported by different people and devices, and it may be stored on the construction site under different and sometimes unfavourable conditions. All these factors may influence the accuracy and functionality of the flowmeter assembly 1 compared to the original factory performance or required specifications. There could be various causes of different problems including but not limiting to: mechanical damage on the flowmeter assembly, in particular the geometry changes of a conduit such as the change of the diameter of the conduit; malfunctioning of one or more transducers, an interference with objects inside a conduit, appearance of dirt and/or grease on the transducers, etc.

FIG. 1d shows in lateral view an exemplary ultrasonic flowmeter assembly 1 comprising a damper system D, in particular damper blade D, arranged downstream of the ultrasonic sensor 2 when seen in flow direction f (correct installation direction).

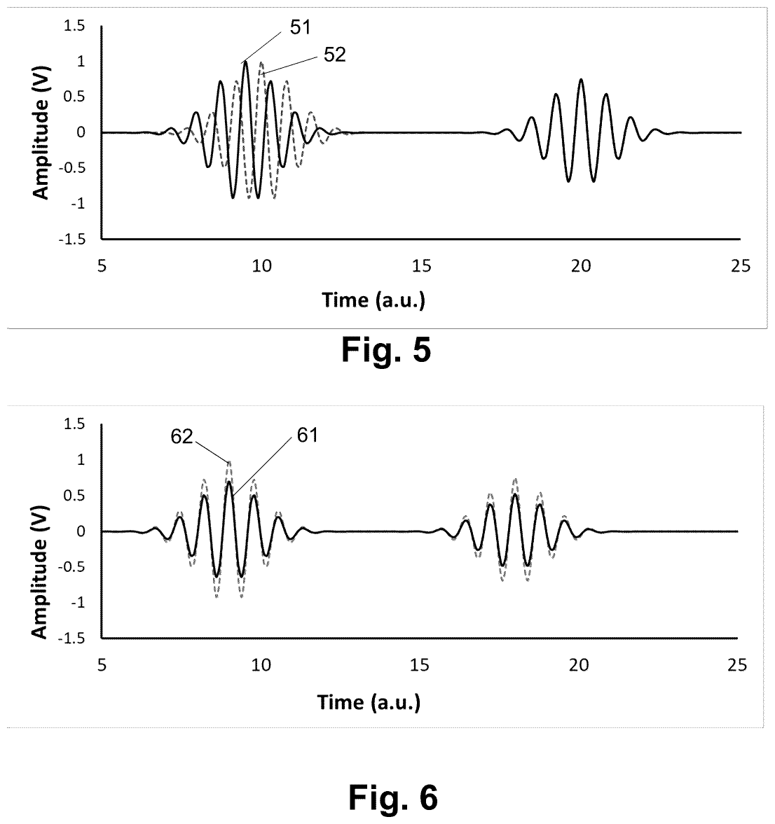

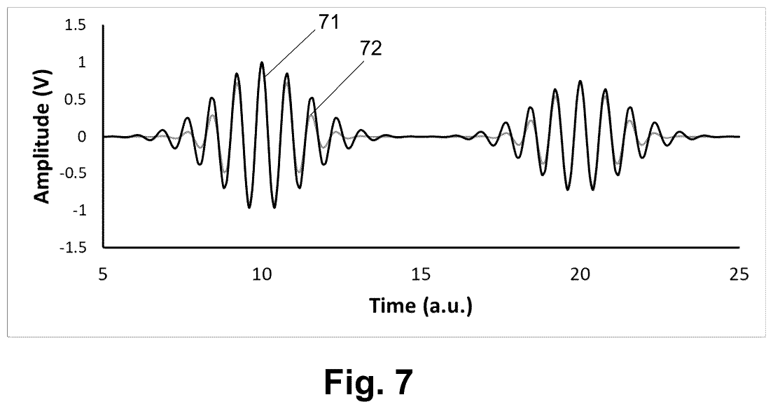

The ultrasonic flowmeter assembly 1 can be equipped with means for detecting a reversed installation with wrong flow direction f through the ultrasonic flowmeter assembly 1. In embodiments of the ultrasonic flowmeter assembly 1 or the self-diagnosing method, in step c) a deviation of the test signal characteristic 52, 62 from the reference signal characteristic 51, 61 (compare FIG. 5, 6) is used to detect a reversed installation direction of the ultrasonic flowmeter assembly 1 (indicated in dashed lines in FIG. 1d), in which the damper system D′, in particular damper blade D′, is arranged upstream of the ultrasonic sensor 2, when seen in flow direction f. Preferably, such a reversed installation is detected only, if the deviation of the test signal characteristic 52, 62 from the reference signal characteristic 51, 61 exceeds a threshold value. Preferably, the deviation is a characteristic parameter, as defined herein.

Preferably, the method of diagnosing or the ultrasonic flowmeter assembly 1 as disclosed herein comprises a step of applying or activating in the controller 200 a corrective calibration curve of the ultrasonic sensor 2, which is designed to compensate ultrasonic signal deviations caused by the reversed installation direction.

Alternatively or in addition, the method of diagnosing or ultrasonic flowmeter assembly 1 as disclosed herein comprises a step of applying or activating in the controller 200 a negative multiplication factor, in particular multiplication factor of minus one, to an output signal of direction-sensitive flow measurement of the ultrasonic flowmeter assembly 1, when it is mounted in reversed installation direction.

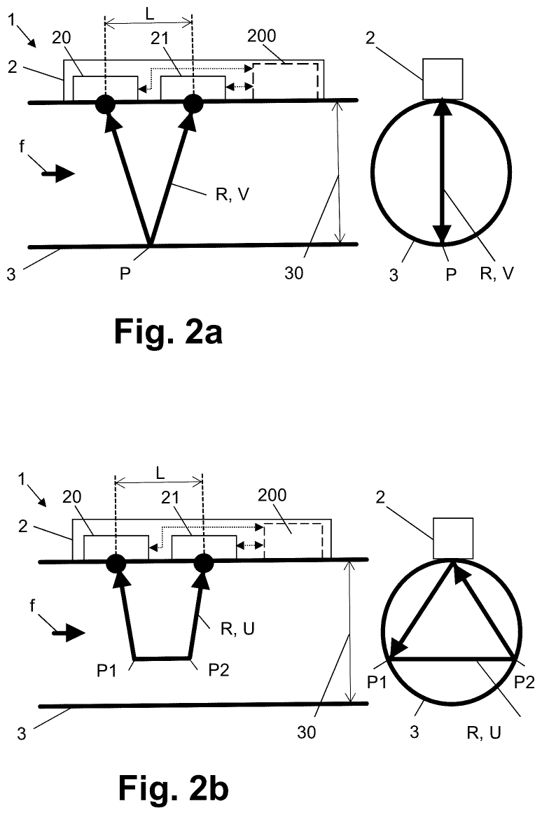

FIG. 2a and FIG. 2b show other embodiments of the ultrasonic flowmeter assembly 1. In this embodiment, the ultrasonic sensor 2 comprises at least two ultrasonic transducers 20, 21 that are fixed to the conduit section 3, and two ultrasonic transducers 20, 21 are arranged at a distance L from each other along the axial direction, and they are configured to emit ultrasonic pulses into the conduit and to receive ultrasonic pulses after having travelled along at least one path R in the conduit section 3.

In the embodiment of FIG. 2a, the reflective path R is a V-shaped path V, which may be in both directions i.e. from the first transducer 20 the second transducer 21 and in the opposite direction. The V-shaped path has one reflection point or area P on the conduit 3. In other words, the first V-path and the second V-path are congruent, i.e. are identical in shape and counter-directional to one another. Differently shaped first paths and/or differently shaped second paths may also be used separately or in combination.

In the embodiment of FIG. 2b, the path R is a U-shaped or quasi-helical-shaped path, which may be in both directions i.e. from the first transducer 20 the second transducer 21 and in the opposite direction as indicated by the arrows. The U-shaped path has two reflection points or areas P1 and P2. The U-shaped path can in particular be considered as a specific quasi-helical path having at least two reflection points P1, P2 and running between the transducers 20, 21. In this context, quasi-helical means that the path comprises a sequence of linear segments that are arranged in a helical manner and approximately form a helical shape, e.g. in one turn (FIG. 2b) or more turns (not shown) around a central conduit axis.

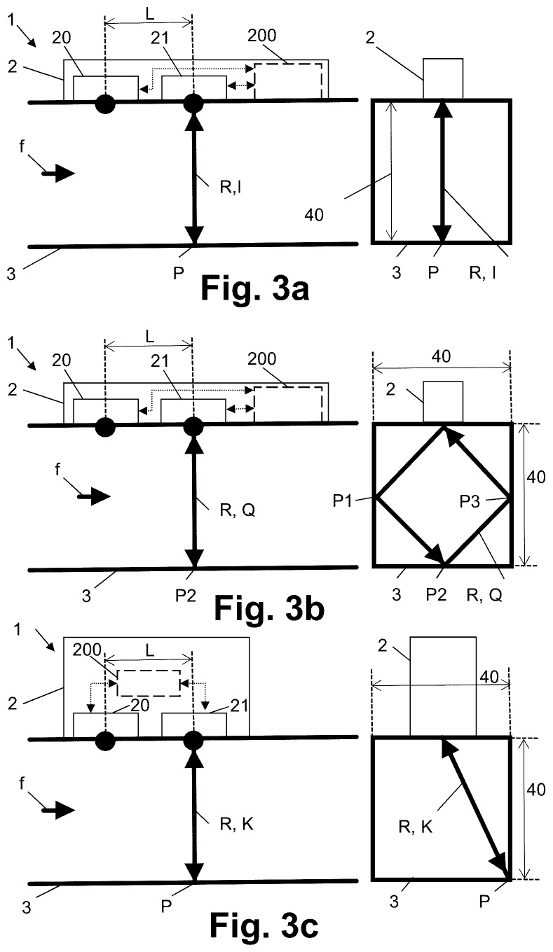

FIG. 3a shows yet another embodiment of the ultrasonic flowmeter assembly 1, wherein the conduit section 3 has a rectangular cross section characterized by the width dimension 40. The reflection path R in this embodiment may preferably be chosen to lie in a plane orthogonal to the flow direction f or a longitudinal axis of the conduit 3. In the double pass I-shaped path, the ultrasonic pulse is reflected once at a reflection point or a reflection area P. FIG. 3b and FIG. 3c show other embodiments of the ultrasonic flowmeter assembly 1, wherein the conduit section has a rectangular cross section providing e.g. a diamond-shaped path Q (FIG. 3b) with three reflection points (P1, P2, P3) and/or a double-pass K-path (FIG. 3c) comprising one reflection point P at an edge region of the conduit 3. These paths are exemplarily shown for the second ultrasonic transducer 21.

According to the invention, a reference measurement and a test measurement are performed each comprising emitting and receiving at least one ultrasonic pulse along at least one same or comparable path R. The reference measurement data provides a reference measurement data, while the test measurement provides a test measurement data. In one embodiment the reference measurement may be a calibration measurement. In another embodiment the reference measurement is provided in advance to obtaining the test measurement data. The reference measurement may be performed at least once before or after installation of the ultrasonic flowmeter assembly 1 at a site of operation. The test measurement data may be obtained repeatedly after installation of the ultrasonic flowmeter assembly at a site of operation. The frequency of performing the test measurement may be predetermined or it may be controlled by the controller 200 and/or an operator. In another embodiment obtaining the reference measurement data is performed during commissioning or during a first start-up procedure of the ultrasonic flowmeter assembly.

In one embodiment the ultrasonic flowmeter assembly 1 is part of a variable air volume (VAV) box. In this embodiment, the reference measurement may be performed after closing sides of the conduit, for example using dampers to enforce zero flow through the conduit 3. The same procedure is performed before making the test measurement.

In the embodiments, the self-diagnosing method of the ultrasonic flowmeter assembly 1 has the following method steps:
(a) providing a reference measurement data;
(b) obtaining a test measurement data;
(c) comparing the reference measurement data and the test measurement data.

The method is characterized in that the reference measurement data comprises a reference signal characteristic of at least one received ultrasonic pulse of the reference measurement, and the test measurement data comprises a test signal characteristic of at least one received ultrasonic pulse of the test measurement.

In one preferred embodiment, the signal characteristic is a waveform of the received ultrasonic pulse. The received waveform is represented as an amplitude of the received signal as a function of time. The amplitude value corresponds to the voltage generated by the transducer.

In one preferred embodiment, obtaining the reference measurement data may be done by using at least two paths R, and obtaining the test measurement data may be done by using the same or comparable at least two paths R. For example, using the combination of I-shaped and delta-shaped paths or the combination of V-shaped path and U-shaped path, or two V-shaped paths in the opposite directions.

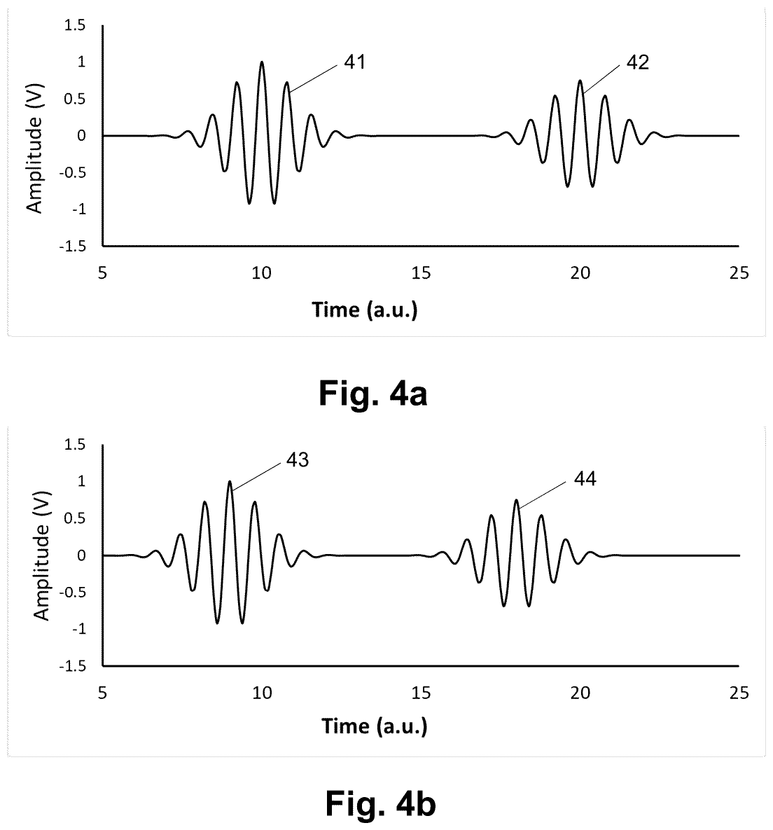

FIG. 4a shows the waveforms 41, 42 of the ultrasonic pulses that are sent along two opposite V-shaped paths of the embodiments shown in FIG. 2a. FIG. 4b shows the waveforms 43, 44 of the ultrasonic pulses that are sent along an I-shaped path and a delta-shaped path of the embodiments shown in FIG. 1a and FIG. 1b.

FIG. 5 shows the waveform of the test measurement 52 superimposed to the waveform of the reference measurement 51. In this case, the two paths are a V-shaped path and a U-shaped path. For the comparison step, at least one characteristic parameter for quantifying a deviation of the test signal characteristics 52 from the reference signal characteristics 51 may be derived. The characteristic parameter may be derived from waveform quantities selected from the list of: an intensity of a waveform amplitude, a shape of a waveform amplitude, a position of a waveform zero-crossing, a position of a waveform extremum, a waveform frequency, and a shape of an enveloping function. This list of parameters is only exemplary and is not limiting.

In this example, the relative shift or position of zero crossing of the test measurement 52 and the reference measurement 51 for V-shaped paths may be used for the comparison. The comparison of the characteristic parameter indicates certain defects in the assembly. Possible causes may include one or more of: a change in a conduit dimension, a change of functioning or malfunctioning of the ultrasonic sensor, a dirt accumulation on the at least one ultrasonic transducer 20, 21, and an interference with an object in the conduit section 3.

In another example shown in FIG. 6, the combination of I-shaped path and delta-shaped path is used for the embodiment corresponding to FIG. 1a and FIG. 1b. In this case, the characteristic parameter used for the comparison is an intensity of the amplitude of the waveform. As observed there is a decrease in the amplitude for both of the paths.

In one embodiment, the alarm may be activated based on the step of comparing, when the characteristic parameter exceeds a threshold value.

FIG. 7 shows a further example of the waveform of the test measurement 72 superimposed to the waveform of the reference measurement 71. In this case, two reflective paths are two opposed V-shaped paths. It can be observed in FIG. 7 that the spreading of the pulse appears indicating certain problems in the ultrasonic flowmeter assembly 1.

Based on the comparison between the test measurement and the reference measurement it is possible to identify or indicate a possible cause of a malfunction of the assembly 1. This may be based on at least one parameter, such as change in the amplitude of the ultrasonic waveform(s) or pulse(s), change of the ultrasonic waveform shape(s) or pulse shape(s), change(s) of ultrasonic waveform or pulse position(s) of two differently shaped paths, frequency change(s) of an ultrasonic transducer, or any combination of such changes.

In the following examples two different paths, e.g. V-shaped path and U-shaped path or I-shaped path and delta-shaped path, are used, and the indication of the physical cause of the ultrasonic signal disturbance(s) is based on two characteristic parameters of the ultrasonic signal(s). By combining two different characteristic parameters, the possible causes may be identified. The results are summarized in the matrixtable given below.

| | | | Positional Change | | |
|---|---|---|---|---|---|
| | Different Pulse | Different Pulse | of V-shaped relative | Frequency | |
| | Shapes on both | Shape on one | to U-shaped path/or | Change of an | Amplitude |
| Amplitude | ultrasonic | ultrasonic | of I-shaped relative to | ultrasonic | Changes |
| Changes | transducers | transducer | delta-shaped path | transducer | only |
| Larger Amplitudes | External Noise | External Noise Source | Duct geometry change | Malfunctioning | — |
| on both paths | Source | | | Transducer | |
| Lower Amplitudes | Water or grease on | Water or grease on | Duct geometry change | Malfunctioning | Dirt |
| on both paths | transducer. | transducer. | | Transducer | |
| | Malfunctioning of | Malfunctioning of one | | | |
| | both transducers | transducer | | | |
| Lower Amplitude | Interferences with | Interferences with | Duct geometry change | Malfunctioning | Dirt |
| on V/I-shaped | object | object | | Transducer | |
| path only | | | | | |
| Lower Amplitude | Interferences with | Interferences with | Duct geometry change | Malfunctioning | Dirt, |
| on U/delta-shaped | object | object | | Transducer | destructive |
| path only | | | | | Interference |
| Same Amplitude | Distortion by object | Malfunctioning of one | Duct geometry change | Malfunctioning | — |
| on both paths | in duct (no dirt) or | transducer | | Transducer | |
| | malfunctioning of | | | | |
| | both transducers | | | | |

To improve the quality of the measurement, reference signal characteristics and/or the test signal characteristics may be obtained by or after conditioning of the measurement data or averaging at least two measurements.

In embodiments each one of the two different paths R is given a weight factor defining the deviation between the test measurement and reference measurement. The path R with highest weight factor corresponding to least deviation may preferably be selected for flow measurement and/or fluid temperature measurement and/or channel dimension measurement.

In general, the path selection may depend on the desired particular ultrasonic flowmeter assembly 1 feature, such as for example detecting a conduit shape and/or conduit dimension 30, 40.

### REFERENCE SYMBOLS

1 Flowmeter assembly
2 ultrasonic sensor
20 first ultrasonic transducer
21 second ultrasonic transducer
200 controller, processor
3 conduit section, part of channel
30, 40 channel dimension
41, 42, 43, 44 reference signal waveforms
51, 61, 71 reference signal waveforms
52, 62, 72 test Signal waveforms
D damper system arranged downstream of ultrasonic sensor
D′ damper system arranged upstream of ultrasonic sensor
f conduit axial direction
L distance between ultrasonic transducers (measured along channel extension)
R path of ultrasonic signal (continuous or quasi-continuous) or ultrasonic pulses; reflective path
V V-shaped path
U U-shaped path, quasi-helical path
I-shaped path; reflective or double-pass I-path; direct or single-pass I-path
K K-path, reflected path from rectangular corner
A delta-shaped path, triangular path
Q diamond-shaped path, quadrilateral path
P, P1, P2 reflection point, reflecting area

1. A method for self-diagnosing an ultrasonic flowmeter assembly which is designed for measuring a flow and/or temperature of a fluid through a channel, the ultrasonic flowmeter assembly comprising:
a conduit section extending in an axial direction; an ultrasonic sensor comprising at least one ultrasonic transducer that is fixed to the conduit section, wherein the at least one ultrasonic transducer is configured to emit ultrasonic pulses into the conduit and to receive ultrasonic pulses after having travelled along at least one path in the conduit section and to output measurement data,
the ultrasonic sensor further comprising a controller connected to the ultrasonic transducer for processing the measurement data,
wherein a reference measurement and a test measurement each comprises emitting and receiving at least one ultrasonic pulse along at least one same or comparable path, the method comprising the method elements of:
(a) providing a reference measurement data;
(b) obtaining a test measurement data;
(c) comparing the reference measurement data and the test measurement data, wherein the reference measurement data comprises a reference signal characteristic of at least one received ultrasonic pulse of the reference measurement, and the test measurement data comprises a test signal characteristic of at least one received ultrasonic pulse of the test measurement,
wherein obtaining the reference measurement data and the test measurement data is done without flow of fluid through the channel.

2. The method of claim 1, wherein the ultrasonic sensor comprises at least two ultrasonic transducers that are fixed to the conduit section and are arranged at a distance from each other along the axial direction, and that are configured to emit ultrasonic pulses into the conduit and to receive ultrasonic pulses after having travelled along at least one path in the conduit section.

3. The method of claim 1, wherein the reference measurement data is obtained at least once before or after installation of the ultrasonic flowmeter assembly at a site of operation, and/or wherein the test measurement data is obtained repeatedly after installation of the ultrasonic flowmeter assembly at a site of operation.

4. The method of claim 1, wherein obtaining the reference measurement data is performed during commissioning or during a first start-up procedure of the ultrasonic flowmeter assembly.

5. The method of claim 1, wherein obtaining the test measurement data is performed automatically as a part of subsequent start-up procedures of the ultrasonic flowmeter assembly; and/or wherein obtaining the test measurement data is initiated repeatedly by the controller.

6. The method of claim 1, wherein the ultrasonic flowmeter assembly is part of a variable air volume box, which is installable in the channel.

7. The method of claim 6, wherein obtaining the reference measurement data and the test measurement data is done by closing a damper of the variable air volume box during normal operation to enforce zero flow.

8. The method of claim 1, wherein obtaining the reference measurement data is done by using at least two paths, and obtaining the test measurement data is done by using the same or comparable at least two paths.

9. The method of claim 1, wherein comparing the reference measurement data and the test measurement data comprises comparing the reference signal characteristics and the test signal characteristics and deriving at least one characteristic parameter for quantifying a deviation of the test signal characteristics from the reference signal characteristics.

10. The method of claim 1, wherein the reference signal characteristic and/or test signal characteristic is or are a waveform of the ultrasonic pulses.

11. The method of claim 10, wherein the characteristic parameter is derived from waveform quantities selected from the list of: an intensity of a waveform amplitude, a shape of a waveform amplitude, a position of a waveform zero-crossing, a position of a waveform extremum, a waveform frequency, or a shape of an enveloping function.

12. The method of claim 1, further comprising a step d) of identifying a cause of a defect of the ultrasonic flowmeter assembly based on the step c) of comparing, in particular based on the at least one characteristic parameter quantifying a deviation of the test signal characteristics from the reference signal characteristics, and wherein the identified cause is one or more of: a change in a conduit dimension, a change of functioning or malfunctioning of the ultrasonic sensor, a dirt accumulation on the at least one ultrasonic transducer and an interference with an object in the conduit section.

13. (canceled)

14. The method of claim 1, wherein the ultrasonic pulses are emitted and received by the same transducer and travel along an I-shaped path and/or a delta-shaped path and/or a diamond-shaped path and/or a K-path, in particular for identifying a change in a conduit dimension.

15. The method of claim 1, wherein the ultrasonic pulses are emitted by a first of the two transducers and are received by a second of the two transducers, in particular for identifying a change in a conduit dimension.

16. The method of claim 2, wherein the ultrasonic pulses are emitted by a first of the two transducers and are received by a second of the two transducers, and the ultrasonic pulses are emitted along a V-shaped path and/or a U-shaped path, preferably for measuring a flow and/or temperature of the fluid.

17. The method of claim 16, wherein the V-shaped path and the U-shaped path are both used, a first characteristic parameter is determined from the reference measurement data and the test measurement data along the V-shaped path, a second characteristic parameter is determined from the reference measurement data and the test measurement data along the U-shaped path, and a change of the first and/or second characteristic parameter, in particular a change in their relationship, is used to identify a cause of defect of the ultrasonic flowmeter assembly.

18. The method of claim 9, wherein the step c) of comparing the reference measurement data and the test measurement data comprises creating a correlation of the reference signal characteristics and the test signal characteristics and using the correlation as the at least one characteristic parameter.

19. The method of claim 1, wherein the reference signal characteristics is stored in the controller; and/or the test signal characteristics is obtained from the controller; and/or the controller performs the self-diagnosing.

20. The method of claim 1, wherein the reference signal characteristics and/or the test signal characteristics is or are obtained by or after conditioning of the measurement data or averaging at least two measurements.

21. A method for self-diagnosing an ultrasonic flowmeter assembly which is designed for measuring a flow and/or temperature of a fluid through a channel, the ultrasonic flowmeter assembly comprising:
a conduit section extending in an axial direction; an ultrasonic sensor comprising at least one ultrasonic transducer that is fixed to the conduit section, wherein the at least one ultrasonic transducer is configured to emit ultrasonic pulses into the conduit and to receive ultrasonic pulses after having travelled along at least one path in the conduit section and to output measurement data,
the ultrasonic sensor further comprising a controller connected to the ultrasonic transducer for processing the measurement data,
wherein a reference measurement and a test measurement each comprises emitting and receiving at least one ultrasonic pulse along at least one same or comparable path, the method comprising the method elements of:
(a) providing a reference measurement data;
(b) obtaining a test measurement data;
(c) comparing the reference measurement data and the test measurement data, wherein the reference measurement data comprises a reference signal characteristic of at least one received ultrasonic pulse of the reference measurement, and the test measurement data comprises a test signal characteristic of at least one received ultrasonic pulse of the test measurement, wherein the reference measurement and the test measurement each comprises emitting and receiving at least one ultrasonic pulse along two different paths, comparing the reference measurement data and the test measurement data for both of the different paths, and wherein each one of the two different paths is given a weight factor defining the deviation between test and reference measurement, and the path with highest weight factor corresponding to least deviation is selected for flow measurement and/or fluid temperature measurement and/or channel dimension measurement.

22. A method for self-diagnosing an ultrasonic flowmeter assembly which is designed for measuring a flow and/or temperature of a fluid through a channel, the ultrasonic flowmeter assembly comprising:
a conduit section extending in an axial direction; an ultrasonic sensor comprising at least one ultrasonic transducer that is fixed to the conduit section, wherein the at least one ultrasonic transducer is configured to emit ultrasonic pulses into the conduit and to receive ultrasonic pulses after having travelled along at least one path in the conduit section and to output measurement data,
the ultrasonic sensor further comprising a controller connected to the ultrasonic transducer for processing the measurement data,
wherein a reference measurement and a test measurement each comprises emitting and receiving at least one ultrasonic pulse along at least one same or comparable path, the method comprising the method elements of:
(a) providing a reference measurement data;
(b) obtaining a test measurement data;
(c) comparing the reference measurement data and the test measurement data, wherein the reference measurement data comprises a reference signal characteristic of at least one received ultrasonic pulse of the reference measurement, and the test measurement data comprises a test signal characteristic of at least one received ultrasonic pulse of the test measurement,
wherein the ultrasonic flowmeter assembly comprises a damper system, and in step c) a deviation of the test signal characteristic from the reference signal characteristic is used to detect a reversed installation direction of the ultrasonic flowmeter assembly, in which the ultrasonic sensor is arranged downstream of the damper system.

23. The method of claim 22, including a step of applying in the controller a corrective calibration curve of the ultrasonic sensor, which is designed to compensate ultrasonic signal deviations caused by the reversed installation direction.

24. The method of claim 22, including a step of applying in the controller a negative multiplication factor, in particular multiplication factor of minus one, to an output signal of a direction-sensitive flow measurement of the ultrasonic flowmeter assembly, when it is mounted in reversed installation direction.

25. The method of claim 1, wherein a reference path during obtaining the reference measurement data and a testing path during obtaining the test measurement data are identical, or are comparable by having known differences in length, orientation and/or shape that can be compensated for by calculation.

26-27. (canceled)

28. The method of claim 21, wherein a reference path during obtaining the reference measurement data and a testing path during obtaining the test measurement data are identical, or are comparable by having known differences in length, orientation and/or shape that can be compensated for by calculation.

29. The method of claim 22, wherein a reference path during obtaining the reference measurement data and a testing path during obtaining the test measurement data are identical, or are comparable by having known differences in length, orientation and/or shape that can be compensated for by calculation.

30. The method of claim 14, wherein the I-shaped path and the delta-shaped path are both used, a first characteristic parameter is determined from the reference measurement data and the test measurement data along the I-shaped path, a second characteristic parameter is determined from the reference measurement data and the test measurement data along the delta-shaped path, and a change of the first and/or second characteristic parameter, in particular a change in their relationship, is used to identify a cause of defect of the ultrasonic flowmeter assembly.
